(19) United States
(12) Patent Application Publication
(10) Pub. No.: US 2025/0164228 A1
(43) Pub. Date: May 22, 2025

(54) POUCH CELL DEFORMATION TESTING APPARATUS AND DEFORMATION TESTING METHOD USING THE SAME

(71) Applicant: LG ENERGY SOLUTION, LTD., Seoul (KR)

(72) Inventor: In Jae JANG, Daejeon (KR)

(73) Assignee: LG ENERGY SOLUTION, LTD., Seoul (KR)

(21) Appl. No.: 18/832,452

(22) PCT Filed: Aug. 9, 2023
(86) PCT No.: PCT/KR2023/011714

§ 371 Date: Jul. 23, 2024

(30) Foreign Application Priority Data
Sep. 21, 2022 (KR) 10-2022-0119267
Jul. 27, 2023 (KR) 10-2023-0098217

(51) Int. Cl. G01B 5/30; H01M 10/42; H01M 50/105

(52) U.S. Cl. CPC G01B 5/30; H01M 10/4285; H01M 50/105

(57) ABSTRACT

An aspect of the current disclosure includes a pouch cell deformation testing apparatus and a deformation testing method using the same. The pouch cell deformation testing apparatus may include a die unit configured to allow a pouch cell to be seated thereon in an erected state, and a measurement member located above the die unit. The measurement member may be configured to measure a flatness of the pouch cell.

### TECHNICAL FIELD

This application claims the benefit of priority to Korean Patent Application No. 2022-0119267 filed on Sep. 21, 2022 and Korean Patent Application No. 2023-0098217 filed on Jul. 27, 2023, the disclosure of which is incorporated herein by reference in its entirety.

The present invention relates to a pouch cell deformation testing apparatus and a pouch cell deformation testing method using the same, and more particularly to a pouch cell deformation testing apparatus capable of measuring whether a bending phenomenon has occurred in a pouch cell during an activation process or after the activation process and a pouch cell deformation testing method using the same.

### BACKGROUND ART

With recent development of alternative energies due to air pollution and energy depletion caused as the result of use of fossil fuels, demand for secondary batteries capable of storing electrical energy that is produced has increased. Secondary batteries, which are capable of being charged and discharged, are intimately used in daily life. For example, secondary batteries are used in mobile devices, electric vehicles, and hybrid electric vehicles.

Based on the structure of an electrode assembly, secondary batteries are classified into a cylindrical secondary battery, a prismatic secondary battery, and a pouch-shaped secondary battery. Thereamong, the pouch-shaped secondary battery is gradually increasing in use because it is possible to obtain high-capacity, high-density secondary batteries, to reduce manufacturing cost, to reduce weight, and to provide various shapes.

The pouch-shaped secondary battery is manufactured by laminating a lower separator, a negative electrode, an upper separator, and a positive electrode in that order, applying heat and pressure thereto through a roll lamination process, and stacking dozens of monocells obtained by cutting. However, a bending phenomenon in which an electrode assembly obtained by lamination is bent in an overall width direction may occur due to various reasons.

In addition, during an activation process of charging, discharging, and stabilizing the pouch-shaped secondary battery, the difference in adhesion between the electrode and the separator in the cell may be generated, whereby the bending phenomenon may occur.

Since bent secondary batteries are at risk of colliding with equipment during transportation to a subsequent process, such as packaging, or ignition due to falling, a series of testing processes to identify deformed secondary batteries is essential.

In connection therewith, Patent Document 1 discloses an apparatus for testing the deformation of a battery container. That is, a pair of pressing plates 2 connected to driven shafts 1 that may be located at opposite side surfaces of a prismatic battery container 10 is provided, and the pressing plates 2 are brought into tight contact with the surface of the battery container 10 to measure the thickness of the deformed battery container 10.

However, in the case of a pouch-shaped battery cell, it is difficult to determine whether the pouch-shaped battery cell has been deformed using the pressing plates because the external shape of the pouch-shaped battery cell is relatively easily changed, and it is impossible to determine which part of the pouch-shaped battery cell has been deformed.

### PRIOR ART DOCUMENT

(Patent Document 1) Japanese Patent Application Publication No. 2014-165059

### DISCLOSURE

### Technical Problem

The present invention has been made in view of the above problems, and it is an object of the present invention to provide a pouch cell deformation testing apparatus capable of testing deformation of a pouch cell that is easy to change in external shape and a testing method using the same.

It is another object of the present invention to provide a pouch cell deformation testing apparatus capable of checking the deformed position of a pouch cell when the pouch cell is deformed and a testing method using the same.

It is a further object of the present invention to provide a pouch cell deformation testing apparatus capable of checking deformation of a pouch cell that is difficult to check with the naked eye before a degassing process and a testing method using the same.

### Technical Solution

An aspect of the current disclosure may include a pouch cell deformation testing apparatus including a die unit configured to allow a pouch cell to be seated thereon in an erected state, and a measurement member located above the die unit, the measurement member being configured to measure a flatness of the pouch cell.

Also, in the pouch cell deformation testing apparatus according to an aspect of the current disclosure, the measurement member may be located at a side surface of the pouch cell.

Also, in the pouch cell deformation testing apparatus according to an aspect of the current disclosure, a plurality of measurement members may be provided in an overall length direction of the pouch cell.

Also, in the pouch cell deformation testing apparatus according to an aspect of the current disclosure, the measurement member may include a hollow receiving portion having a viewing window, a moving bar received in the hollow receiving portion, a dog mounted to the moving bar, a spring received in the receiving portion, one end of the spring being fixed to the receiving portion, an other end of the spring being connected to one end of the moving bar, and a first sensing portion located in a vicinity of the hollow receiving portion, wherein one end of the spring is fixed to the hollow receiving portion, and an other end of the spring is connected to one end of the moving bar, wherein the dog may be exposed to an outside through the viewing window, wherein a contact portion protruding out of the hollow receiving portion may be provided at an other end of the moving bar, and wherein the first sensing portion may detect the dog only when the dog is exposed to the outside through the viewing window.

Also, in the pouch cell deformation testing apparatus according to an aspect of the current disclosure, the contact portion may be made of an elastic material and may be conical in shape.

Also, the pouch cell deformation testing apparatus according to an aspect of the current disclosure may further include a driving unit configured to move the hollow receiving portion forwards toward the side surface of the pouch cell or rearwards, wherein the driving unit may include a first fixing bar located vertically and fastened to the measurement member, a second fixing bar fastened to one side of the first fixing bar and located parallel to the measurement member, a guide rail configured to provide the movement path of the second fixing bar, and a linear motion member configured to reciprocate the second fixing bar in a straight line by a set distance.

Also, in the pouch cell deformation testing apparatus according to an aspect of the current disclosure, further including a plurality of hollow receiving portions spaced apart from each other by a certain distance in an overall width direction of the pouch cell, wherein the first fixing bar may be fastened to the plurality of receiving portions.

Also, in the pouch cell deformation testing apparatus according to an aspect of the current disclosure, the hollow receiving portions may be located at a lower edge, at an upper edge, and between the lower edge and the upper edge of the pouch cell in the overall width direction of the pouch cell.

Also, in the pouch cell deformation testing apparatus according to an aspect of the current disclosure, the hollow receiving portions may be located at one side edge, at an other side edge, and between the one side edge and the other side edge of the pouch cell in the overall length direction.

Also, in the pouch cell deformation testing apparatus according to an aspect of the current disclosure, the measurement member may include a hollow receiving portion, and a second sensing portion received in the hollow receiving portion, wherein the second sensing portion may be provided with a second sensor configured to measure the distance to the pouch cell in a non-contact manner.

In addition, a pouch cell deformation testing method according to an aspect of the current disclosure may include a first step of locating a pouch cell disposed vertically, and a second step of determining whether the pouch cell is normal based on a flatness of the pouch cell using a measurement member located at a side surface of the pouch cell, wherein the measurement member measures the flatness of the pouch cell in a contact manner or a non-contact manner.

Also, in the pouch cell deformation testing method according to an aspect of the current disclosure, wherein the measurement member may include a hollow receiving portion having a viewing window, a moving bar received in the hollow receiving portion, a dog mounted to the moving bar, a spring received in the hollow receiving portion, one end of the spring being fixed to the receiving portion, an other end of the spring being connected to one end of the moving bar (220), and a first sensing portion located in a vicinity of the hollow receiving portion, wherein in the second step, the hollow receiving portion is moved toward the side surface of the pouch cell until the hollow receiving portion reaches a set position, in the state in which the hollow receiving portion is located orthogonal to the side surface of the pouch cell, wherein when the dog is exposed to an outside through the viewing window and the first sensing portion detects the dog, the pouch cell may be determined to be normal, and when the first sensing portion does not detect the dog, the pouch cell may be determined to be abnormal.

Also, in the pouch cell deformation testing method according to an aspect of the current disclosure, a plurality of measurement members may be provided at one side surface or opposite side surfaces of the pouch cell.

Also, in the pouch cell deformation testing method according to an aspect of the current disclosure, in the second step, a plurality of hollow receiving portions spaced apart from each other by a certain distance along an overall length of the pouch cell may be moved to the one side surface or the opposite side surfaces of the pouch cell.

Also, in the pouch cell deformation testing method according to an aspect of the current disclosure, in the second step, a plurality of receiving portions spaced apart from each other by a certain distance along an overall width of the pouch cell may be moved to the one side surface or the opposite side surfaces of the pouch cell.

Also, in the pouch cell deformation testing method according to an aspect of the current disclosure, when the dog (230) is not detected in the second step, an alarm may be generated.

### Advantageous Effects

As is apparent from the above description, a pouch cell deformation testing apparatus according to the present invention and a pouch cell deformation testing method using the same have an advantage in that it is possible to determine whether a pouch cell has been deformed in a contact manner or a non-contact manner.

In addition, the pouch cell deformation testing apparatus according to the present invention and the pouch cell deformation testing method using the same have an advantage in that a dog movable to one side surface or opposite side surface of the pouch cell and a sensing portion capable of detecting the dog are provided, whereby it is possible to easily determine whether the pouch cell has been deformed.

In addition, the pouch cell deformation testing apparatus according to the present invention and the pouch cell deformation testing method using the same have a merit in that a plurality of dogs movable to one side surface or opposite side surface of the pouch cell and a sensing portion capable of detecting the dogs are provided, whereby it is possible to check the deformed position of the pouch cell.

Furthermore, the pouch cell deformation testing apparatus according to the present invention and the pouch cell deformation testing method using the same have an advantage in that a plurality of dogs movable to one side surface or opposite side surface of the pouch cell is detected, whereby it is possible to determine the degree of deformation of the pouch cell.

### DESCRIPTION OF DRAWINGS

FIG. 1 is a perspective view of a conventional apparatus for testing deformation of a battery container.

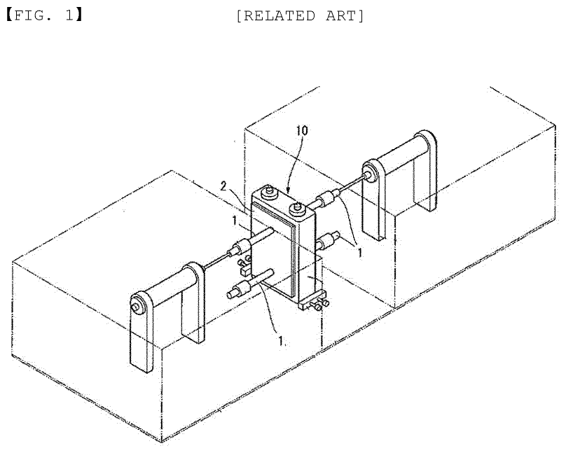

FIG. 2 is a view showing the state in which a pouch cell is mounted in a pouch cell deformation testing apparatus according to a first preferred embodiment of the present invention.

FIG. 3 is a schematic view of the pouch cell deformation testing apparatus according to the first preferred embodiment of the present invention.

FIG. 4 is a perspective view of a measurement member provided in the pouch cell deformation testing apparatus according to the first preferred embodiment of the present invention.

FIG. 5 is an exploded perspective view of the measurement member shown in FIG. 4.

FIG. 6 is a perspective view of a modified measurement member provided in the pouch cell deformation testing apparatus according to the first preferred embodiment of the present invention.

FIG. 7 is a perspective view showing the structure in which the measurement member and a driving unit are coupled to each other in the pouch cell deformation testing apparatus according to the first preferred embodiment of the present invention.

FIG. 8 is a schematic view of a pouch cell deformation testing apparatus according to a second preferred embodiment of the present invention.

FIG. 9 is a perspective view of a measurement member provided in the pouch cell deformation testing apparatus according to the second preferred embodiment of the present invention.

FIG. 10 is a view illustrating the position of a dog when a normal pouch cell is mounted in the testing apparatus according to the first preferred embodiment of the present invention.

FIG. 11 is a view illustrating the position of the dog when an abnormal pouch cell is mounted in the testing apparatus according to the first preferred embodiment of the present invention.

FIG. 12 is a view illustrating the position of a second sensor when a normal pouch cell is mounted in the testing apparatus according to the second preferred embodiment of the present invention.

FIG. 13 is a view illustrating the position of the second sensor when an abnormal pouch cell is mounted in the testing apparatus according to the second preferred embodiment of the present invention.

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is the to be connected to another part in the entire specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a pouch cell deformation testing apparatus according to the present invention and a testing method using the same will be described with reference to the accompanying drawings.

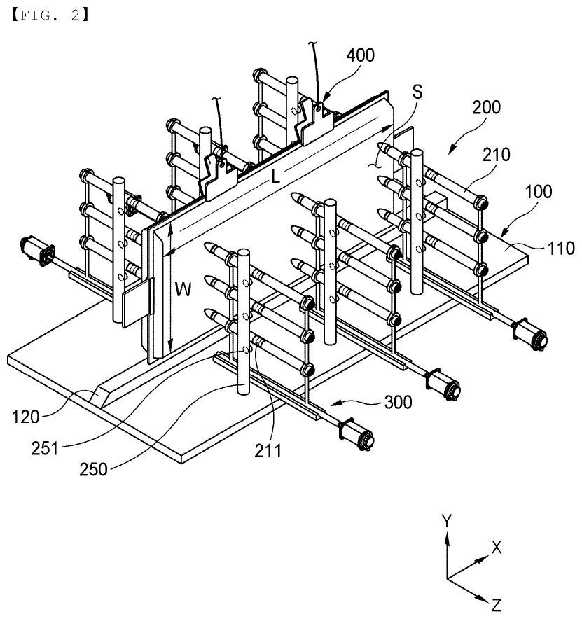

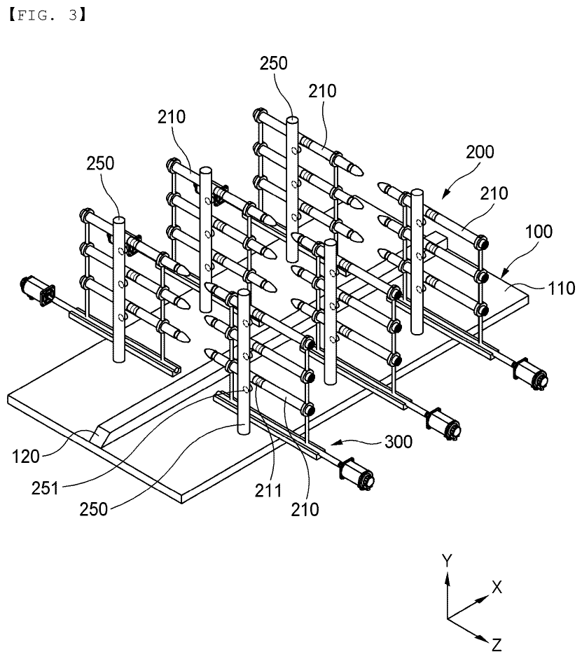

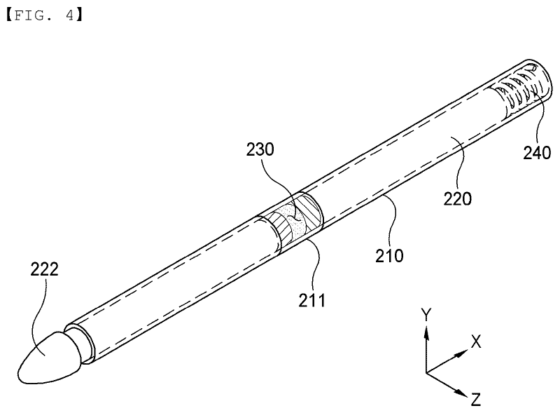

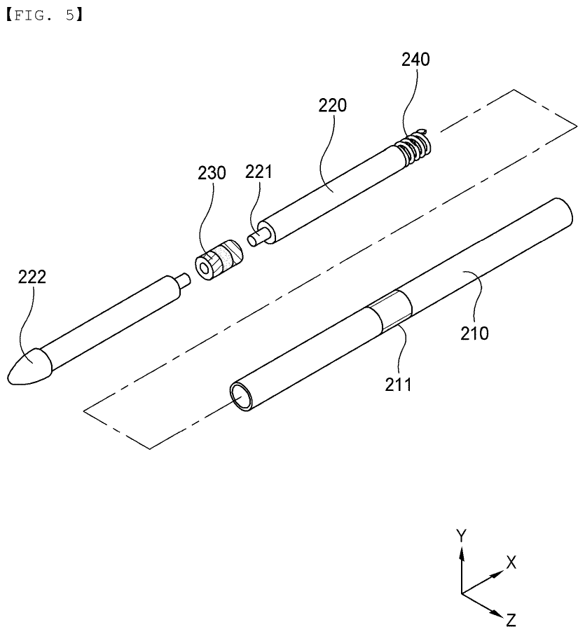

FIG. 2 is a view showing the state in which a pouch cell is mounted in a pouch cell deformation testing apparatus according to a first preferred embodiment of the present invention, FIG. 3 is a schematic view of the pouch cell deformation testing apparatus according to the first preferred embodiment of the present invention, FIG. 4 is a perspective view of a measurement member provided in the pouch cell deformation testing apparatus according to the first preferred embodiment of the present invention, and FIG. 5 is an exploded perspective view of the measurement member shown in FIG. 4.

As shown in FIGS. 2 to 5, the pouch cell deformation testing apparatus according to the first embodiment of the present invention comprises a die unit 100, a measurement member 200, a driving unit 300, and a holding means 400.

First, the die unit 100 may include a plate-shaped base 110 and a seating portion 120. The seating portion 120, which is disposed across the base 110, is configured to indicate the exact seating position of a pouch cell S, which is a target to be tested, and preferably protrudes slightly farther than an upper surface of the base 110.

The measurement member 200 is located at one side surface or opposite side surfaces of the pouch cell S and is configured to physically determine the flatness of the pouch cell S, i.e. whether a bending phenomenon has occurred.

The measurement member 200 may include a cylindrical hollow receiving portion 210, a moving bar 220 received in the receiving portion 210, a dog 230 mounted to the moving bar 220, a spring 240, which is an elastic body, and a first sensing portion 250 located in the vicinity of the receiving portion 210.

First, the receiving portion 210 is configured to guide the moving bar 220 having the dog 230 mounted thereto, and a viewing window 211 configured to allow the position of the dog 230 to be checked therethrough is provided in a predetermined region of the receiving portion 210.

Here, the viewing window 211 may be blocked from the outside by a transparent material, such as glass, or may be simply open.

The moving bar 220 having the dog 230 mounted thereto is movable depending on whether the pouch cell S is flat or not.

Specifically, one end of the moving bar 220, which has a cylindrical shape, is connected to one side of the spring 240, and the other side of the spring 240 is fixed to one side of the receiving portion 210.

In addition, a contact portion 222 located so as to protrude out of the receiving portion 210 is provided at the other end of the moving bar 220. When no external force is applied, therefore, the moving bar 220 is immobile, but when pressed by a curved portion of the pouch cell S, i.e. an outwardly curved portion, the moving bar moves in a direction in which the spring 240 is located, and at this time the dog 230 also moves therewith.

The moving bar 220 may be constituted by two pieces separable from each other, which may be fastened to each other, for example, by male and female engagement; however, the present invention is not limited thereto, and a fastening part therebetween is preferably provided at an extension portion 221 such that attachment and detachment of the dog 230 are easily achieved.

In other words, a bar-shaped extension portion 221 having a reduced outer diameter may be provided at a set position of the moving bar 220, for example in the vicinity of the center thereof at which the pieces constituting the moving bar are connected to each other, and the dog 230 is mounted to the extension portion 221.

The contact portion 222 is preferably approximately conical in shape, and is more preferably made of an elastic material, such as rubber or silicone, in order to prevent damage to the pouch cell S. Of course, the structure of the contact portion may be variously changed as long as the pouch cell S is not damaged. For example, the contact portion may be a spring or may be configured in a form in which an outer surface of the spring is enclosed by rubber.

Next, the dog 230 will be described. As previously described, the dog 230 is doughnut-shaped, is mounted to the extension portion 221 of the moving bar 220, and is located so as to be exposed through the viewing window 211 in the state in which the contact portion 222 of the moving bar 220 and the pouch cell S are not in contact.

The dog 230 may be detected by the first sensing portion 250. Specifically, the first sensing portion 250 is located orthogonal to the receiving portion 210, and a first sensor 251 capable of recognizing the dog 230 is provided at the position of the dog that faces the viewing window 211.

Consequently, the first sensor 251 can detect the dog 230 only through the viewing window 211 of the receiving portion 210, and cannot detect the dog 230 when the dog moves to the left and right of the viewing window 211.

For example, a coating layer made of colored ink is formed on an outer surface of the dog 230, and the first sensor 251 may be a color sensor capable of detecting the coating layer of the dog 230. In particular, when the ink forming the coating layer on the outer surface of the dog 230 is formed in the shape of a band formed at a certain interval and a plurality of coating layers having different colors is provided, it is possible to detect the movement distance of the dog 230 through color change.

Of course, the dog 230 and the first sensor 251 are not limited to the above example as long as the dog 230 is detectable.

After an activation process, a bending phenomenon may occur along the overall width W of the pouch cell S, i.e. the surface thereof along which electrode leads are provided. Consequently, it is preferable for a plurality of receiving portions 210 to be located so as to be spaced apart from each other by a certain distance along the overall width of the pouch cell S, and it is more preferable for the receiving portions 210 to be located at a lower edge, at an upper edge, and between the lower edge and the upper edge of the pouch cell S.

When the receiving portions 210 are located, as described above, it is possible to determine whether the bending phenomenon has occurred in a certain region of the overall width W.

In particular, when the receiving portions 210 are located at one side edge, at the other side edge, and between the one side edge and the other side edge of the pouch cell S along the overall length L thereof, it is possible to determine whether the bending phenomenon has occurred in almost the entire region of the pouch cell S.

Meanwhile, it is preferable for the measurement members 200 to be located at opposite side surfaces of the pouch cell S so as to correspond to each other, rather than only at one side surface of the pouch cell S. The reason for this is that, even when any one of the measurement members 200 malfunctions, it is possible to increase the accuracy of the test results.

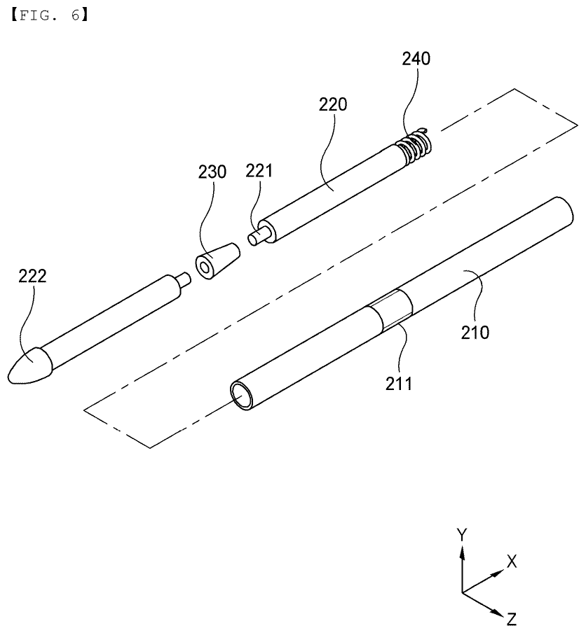

FIG. 6 is a perspective view of a modified measurement member provided in the pouch cell deformation testing apparatus according to the first preferred embodiment of the present invention. It is also possible to use the modified measurement member, as shown in FIG. 6.

That is, in the modified measurement member, a dog 230 having an approximately conical shape with the maximum outer diameter smaller than the outer diameter of a moving bar 220 is provided on an extension portion 221 of the moving bar 220, and a first sensor mounted to a first sensing portion is a proximity displacement sensor, such as a laser sensor, an ultrasonic sensor, or an infrared sensor. When the modified measurement member is used, it is not only possible to determine whether a dog 230 is located in a viewing window 211 but also possible to check the movement distance of the dog 230 due to the conical shape thereof.

Referring back to FIGS. 2 to 5, the first sensor 251 is mounted to the first sensing portion 250. In order to detect all dogs 230, it is preferable to provide the same number of first sensors 251 as the viewing windows 211 of the receiving portions 210, and it is more preferable for the first sensors to be located on the same horizontal lines as the viewing windows 211.

Although the first sensing portion 250 is shown as being located at the base 110 in the figures, the present invention is not limited thereto.

Meanwhile, the holding means 400 is configured to move and temporarily hold a pouch cell S to be tested, and is not particularly restricted as long as the holding means does not cause damage to the pouch cell S. As an example, the holding means may be tongs or a vacuum suction plate.

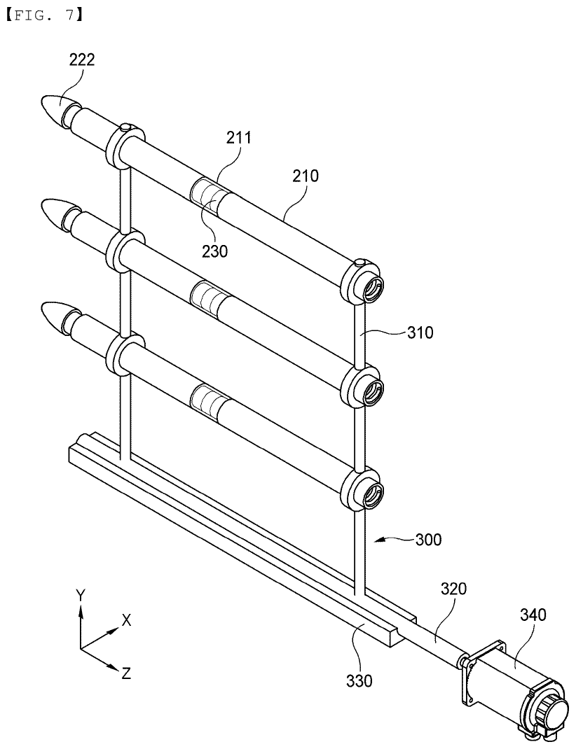

FIG. 7 is a perspective view showing the structure in which the receiving portion and the driving unit are coupled to each other in the pouch cell deformation testing apparatus according to the first preferred embodiment of the present invention.

In order to check the bending phenomenon of the pouch cell S, the receiving portion 210 must be located orthogonal to the side surface of the pouch cell S. Preferably, a plurality of receiving portions 210 is used to check bent parts.

The driving unit 300 is configured to move the receiving portion 210 in a direction orthogonal to the side surface of the pouch cell S and to connect a plurality of receiving portions 210 to each other.

Specifically, the driving unit 300 includes a first fixing bar 310 fastened to the receiving portion 210, a second fixing bar 320 fastened to one side of the first fixing bar 310, a guide rail 330 configured to provide the movement path of the second fixing bar 320, and a linear motion member 340.

The first fixing bar 310 is configured to fix and support the plurality of receiving portions 210 disposed in the overall width direction of the pouch cell S, and is erected in a direction orthogonal to the receiving portion 210, i.e. vertically. Here, a fastening method or means is not particularly limited as long as the first fixing bar 310 and the receiving portion 210 can be fastened to each other. Although two first fixing bars 310 are shown in the figures, which is only an example, and the number of the first fixing bars may be changed.

The second fixing bar 320 is configured to fix and support the vertically erected first fixing bar 310, and is located parallel to the receiving portion 210. A method of fastening therebetween is not particularly limited. Although the first fixing bar 310 and the second fixing bar 320 have been described separately, these fixing bars may be integrated into a single body.

The guide rail 330 is configured to guide the second fixing bar 320 so as to accurately move in a direction orthogonal to the side surface of the pouch cell S, and may have a recessed groove formed in a longitudinal direction thereof.

The linear motion member 340 connected to one side of the second fixing bar 320 is configured to reciprocate the second fixing bar 320 in a straight line, and is not particularly limited as long as it is possible to linearly move the second fixing bar 320 by a predetermined distance. Preferably, the linear motion member is a servomotor or a pneumatic cylinder.

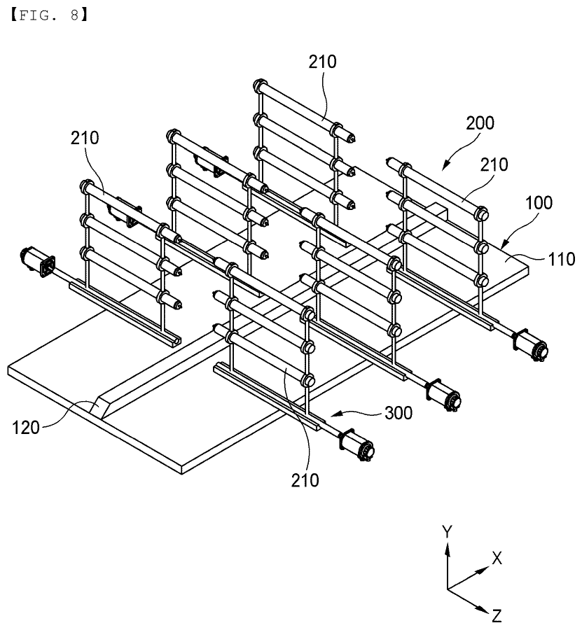

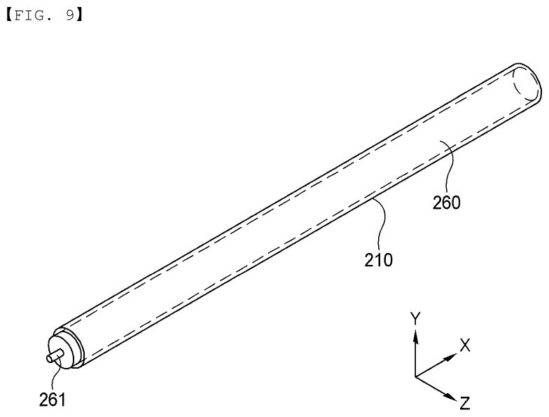

FIG. 8 is a schematic view of a pouch cell deformation testing apparatus according to a second preferred embodiment of the present invention, and FIG. 9 is a perspective view of a measurement member provided in the pouch cell deformation testing apparatus according to the second preferred embodiment of the present invention.

The testing apparatus according to the second preferred embodiment of the present invention is identical to the first embodiment except for a measurement member 200. In other words, the measurement member of the second embodiment includes a hollow receiving portion 210 and a second sensing portion 260 received in the receiving portion 210, wherein a second sensor 261 capable of measuring the distance to the pouch cell S in a non-contact manner is mounted to the second sensing portion 260, and the second sensor is a proximity displacement sensor, such as a laser sensor, an ultrasonic sensor, or an infrared sensor.

Next, a pouch cell deformation testing method using the testing apparatus according to the first preferred embodiment of the present invention described above will be described.

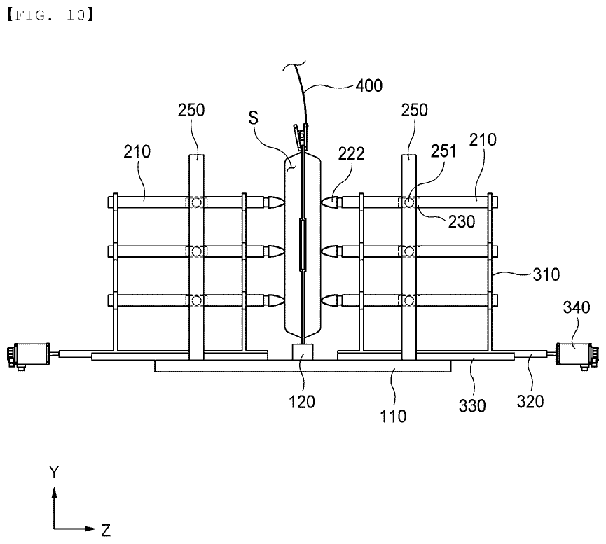

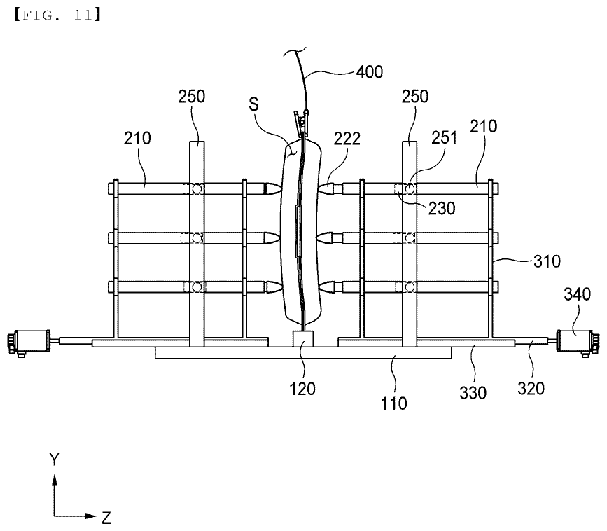

FIG. 10 is a view illustrating the position of the dog when a normal pouch cell is mounted in the testing apparatus according to the first preferred embodiment of the present invention, and FIG. 11 is a view illustrating the position of the dog when an abnormal pouch cell is mounted in the testing apparatus according to the first preferred embodiment of the present invention.

Referring to these figures, a method of testing deformation of a pouch cell S according to the present invention includes a first step of locating the pouch cell S vertically, and a second step of determining whether the pouch cell S is normal based on the flatness of the pouch cell S using the measurement member 200 located at the side surface of the pouch cell S.

First, in the first step, the pouch cell S is located perpendicular to the ground or the base and fixed using the holding means 400. Of course, the overall length of the pouch cell S is parallel to the base in order to prevent electrode leads from colliding with the base.

In the second step, the receiving portion 210 is moved toward the side surface of the pouch cell S until the receiving portion reaches a set position, more specifically until the receiving portion comes into tight contact with or comes close to the pouch cell S, in the state in which the receiving portion is located orthogonal to the side surface of the pouch cell S. At this time, it is obvious that the distance between the measurement member 200 and the pouch cell S must be measured in advance.

The linear motion member 340 moves the plurality of receiving portions 210 spaced apart from each other by a certain distance along the overall length and overall width of the pouch cell S, preferably toward one side surface of the pouch cell S, more preferably toward opposite side surfaces of the pouch cell S, and most preferably moves all of the receiving portions 210 by the same distance.

Whether the pouch cell S is normal is determined based on the position of the dog 230. As shown in FIG. 10, when the pouch cell S is normal, i.e. there is no bending phenomenon, the contact portions 222 of the receiving portions 210 that have been moved from opposite sides of the pouch cell S are simply in contact or very close to the side surfaces of the pouch cell S. As a result, all of the dogs 230 are exposed through the viewing windows 211 and may be detected by the first sensors 251.

On the other hand, when the pouch cell S is abnormal, i.e. a bending phenomenon has occurred at a part of the pouch cell, as shown in FIG. 11, some of the contact portions 222 of the receiving portions 210 that have been moved from opposite sides of the pouch cell S cannot be moved to set positions.

In other words, the portion of the pouch cell that is bent in a direction in which the receiving portion 210 approaches pushes the contact portion 222 received in the receiving portion 210, whereby the dog 230 cannot be located in the viewing window 211 and thus cannot be detected by the first sensor 251, or even though the dog 230 is located in the viewing window 211, the dog is moved beyond a set range, whereby only a part of the dog 230 is located in the viewing window.

As described above, when all of the dogs 230 are detected, the pouch cell S is determined to be normal with no bending phenomenon, and when some of the dogs 230 are not detected, or the dogs 230 are moved beyond the set range even though the dogs are detected, the pouch cell S is determined to be abnormal.

When the pouch cell S is determined to be abnormal, it is preferable to further include a step of generating an alarm, such as a sound, for easy recognition by a worker.

Meanwhile, when a measurement member 200 having a dog 230 having a conical shape with the configuration shown in FIG. 6 is used, it is possible to determine whether the pouch cell S is defective by measuring the distance between the dog 230 and the first sensor 251.

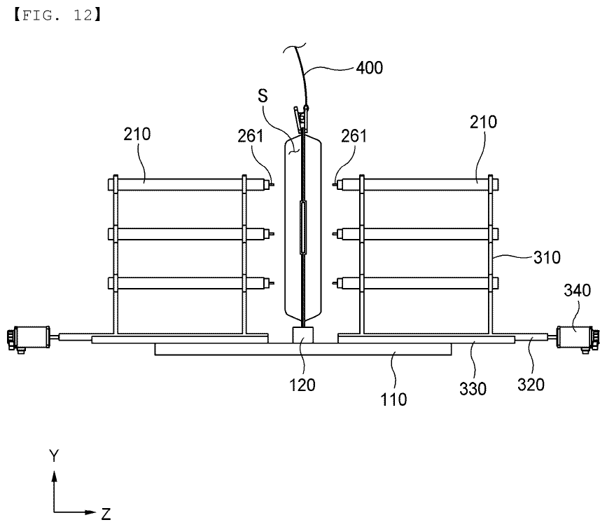

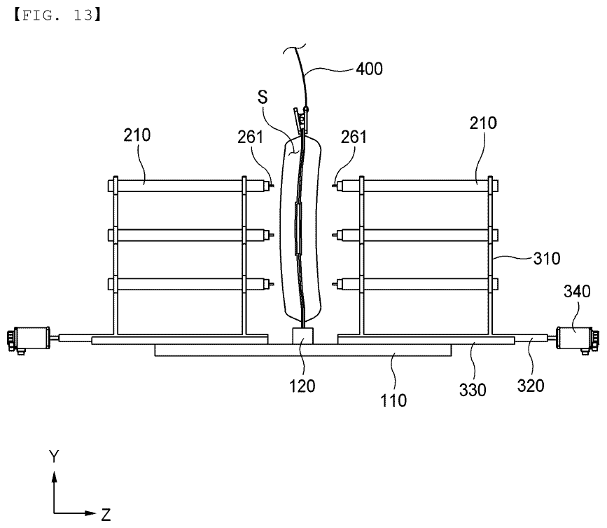

FIG. 12 is a view illustrating the position of a second sensor when a normal pouch cell is mounted in the testing apparatus according to the second preferred embodiment of the present invention, and FIG. 13 is a view illustrating the position of the second sensor when an abnormal pouch cell is mounted in the testing apparatus according to the second preferred embodiment of the present invention.

When the testing apparatus according to the second embodiment is used, the second sensor 261 is located so as to be spaced apart from the pouch cell S by a certain distance, and then the distance between the pouch cell S and the second sensor 261 is measured. When all of the measured results are within a set range, the pouch cell is determined to be normal, and when one or more results deviate from the set range, the pouch cell is determined to be defective.

Compared to the testing apparatus according to the first embodiment, the testing apparatus according to the second embodiment has the advantage that the testing apparatus does not need to be moved until the testing apparatus comes into tight contact with or comes close to the pouch cell S.

The present invention has been described above with reference to specific embodiments. However, those skilled in the art to which the present invention pertains will appreciate that various applications and modifications are possible within the category of the present invention based on the above description.

### DESCRIPTION OF REFERENCE SYMBOLS

100: Die unit
110: Base
120: Seating portion
200: Measurement member
210: Receiving portion 211: Viewing window
220: Moving bar
221: Extension portion 222: Contact portion
230: Dog
240: Spring
250: First sensing portion 251: First sensor
260: Second sensing portion 261: Second sensor
300: Driving unit
310: First fixing bar
320: Second fixing bar
330: Guide rail
340: Linear motion member
400: Holding means
S: Pouch cell
L: Overall length
W: Overall width

1. A pouch cell deformation testing apparatus comprising:
a die unit configured to allow a pouch cell to be seated thereon in an erected state; and
a measurement member located above the die unit, the measurement member being configured to measure a flatness of the pouch cell.

2. The pouch cell deformation testing apparatus according to claim 1, wherein the measurement member is located at a side surface of the pouch cell.

3. The pouch cell deformation testing apparatus according to claim 2, wherein a plurality of measurement members are provided in an overall length direction of the pouch cell.

4. The pouch cell deformation testing apparatus according to claim 3, wherein the measurement member comprises:
a hollow receiving portion having a viewing window,
a moving bar received in the hollow receiving portion,
a dog mounted to the moving bar,
a spring received in the hollow receiving portion, and
one end of the spring being fixed to the receiving portion, an other end of the spring being connected to one end of the moving bar, and
a first sensing portion located in a vicinity of the hollow receiving portion,
wherein the dog is exposed to an outside through the viewing window,
wherein a contact portion protruding out of the hollow receiving portion is provided at an other end of the moving bar, and
wherein the first sensing portion detects the dog only when the dog is exposed to the outside through the viewing window.

5. The pouch cell deformation testing apparatus according to claim 4, wherein the contact portion is made of an elastic material and is conical in shape.

6. The pouch cell deformation testing apparatus according to claim 4, further comprising:
a driving unit configured to move the hollow receiving portion forwards toward the side surface of the pouch cell or rearwards,
wherein the driving unit comprises:
a first fixing bar located vertically and fastened to the measurement member,
a second fixing bar fastened to one side of the first fixing bar and located parallel to the measurement member,
a guide rail configured to provide a movement path of the second fixing bar, and
a linear motion member configured to reciprocate the second fixing bar in a straight line by a set distance.

7. The pouch cell deformation testing apparatus according to claim 6, further comprising a plurality of hollow receiving portions spaced apart from each other by a certain distance in an overall width direction of the pouch cell,
wherein the first fixing bar is fastened to the plurality of hollow receiving portions.

8. The pouch cell deformation testing apparatus according to claim 7, wherein the hollow receiving portions are located at a lower edge, at an upper edge, and between the lower edge and the upper edge of the pouch cell in the overall width direction of the pouch cell.

9. The pouch cell deformation testing apparatus according to claim 7, wherein the hollow receiving portions are located at one side edge, at an other side edge, and between the one side edge and the other side edge of the pouch cell in the overall length direction.

10. The pouch cell deformation testing apparatus according to claim 3, wherein the measurement member comprises:
a hollow receiving portion, and
a second sensing portion received in the hollow receiving portion,
wherein the second sensing portion is provided with a second sensor configured to measure a distance to the pouch cell in a non-contact manner.

11. A pouch cell deformation testing method comprising:
a first step of locating a pouch cell disposed vertically; and
a second step of determining whether the pouch cell is normal based on a flatness of the pouch cell using a measurement member located at a side surface of the pouch cell,
wherein the measurement member measures the flatness of the pouch cell in a contact manner or a non-contact manner.

12. The pouch cell deformation testing method according to claim 11, wherein the measurement member comprises:
a hollow receiving portion having a viewing window,
a moving bar received in the hollow receiving portion,
a dog mounted to the moving bar,
a spring received in the hollow receiving portion, one end of the spring being fixed to the receiving portion, an other end of the spring being connected to one end of the moving bar, and
a first sensing portion located in a vicinity of the hollow receiving portion,
wherein in the second step, the hollow receiving portion is moved toward the side surface of the pouch cell until the hollow receiving portion reaches a set position, in a state in which the hollow receiving portion is located orthogonal to the side surface of the pouch cell,
wherein when the dog is exposed to an outside through the viewing window and the first sensing portion detects the dog, the pouch cell is determined to be normal, and when the first sensing portion does not detect the dog, the pouch cell is determined to be abnormal.

13. The pouch cell deformation testing method according to claim 12, wherein a plurality of measurement members are provided at one side surface or opposite side surfaces of the pouch cell.

14. The pouch cell deformation testing method according to claim 13, wherein, in the second step, a plurality of hollow receiving portions spaced apart from each other by a certain distance along an overall length of the pouch cell are moved to the one side surface or the opposite side surfaces of the pouch cell.

15. The pouch cell deformation testing method according to claim 13, wherein, in the second step, a plurality of hollow receiving portions spaced apart from each other by a certain distance along an overall width of the pouch cell are moved to the one side surface or the opposite side surfaces of the pouch cell.

16. The pouch cell deformation testing method according to claim 12, wherein, when the dog is not detected in the second step, an alarm is generated.
